(19) United States
(12) Patent Application Publication
(10) Pub. No.: US 2026/0019130 A1
(43) Pub. Date: Jan. 15, 2026

(54) CHANNEL STATE INFORMATION PROCESSING UNIT

(71) Applicant: ZTE Corporation, Shenzhen (CN)

(72) Inventors: Xiaoying MA, Shenzhen (CN); Mengzhu CHEN, Shenzhen (CN); Hong TANG, Shenzhen (CN); Jun XU, Shenzhen (CN); Bo DAI, Shenzhen (CN); Xuan MA, Shenzhen (CN)

(21) Appl. No.: 19/338,228

(22) Filed: Sep. 24, 2025

Related U.S. Application Data
(63) Continuation of application No. PCT/CN2023/085172, filed on Mar. 30, 2023.

(51) Int. Cl. H04B 7/06; H04L 5/00; H04W 24/10

(52) U.S. Cl. CPC H04B 7/0626; H04L 5/0051; H04W 24/10

(57) ABSTRACT

Systems, methods, and apparatus for wireless communication are described. A wireless communication method includes receiving, by a wireless device, one or more channel state information (CSI) report configurations, where each CSI report configuration of the one or more CSI report configurations configures one or more CSI reports. The method further includes determining, by the wireless device, a number of CSI processing units (CPUs) occupied by one or more CSI reports configured by a CSI report configuration of the one or more CSI report configurations. The method further includes processing, by the wireless device, one or more sets of CSIs based on a predefined rule related to the number of CPUs occupied by the one or more CSI reports. The described techniques may be adopted by a network device or by a wireless device.

### CROSS-REFERENCE TO RELATED APPLICATION

This application is a continuation and claims priority to International Application No. PCT/CN2023/085172, filed on Mar. 30, 2023, the disclosure of which is hereby incorporated by reference herein in its entirety.

### TECHNICAL FIELD

This patent document is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability, and other emerging business needs.

### SUMMARY

Techniques are disclosed for determining the number of channel state information (CSI) processing units (CPUs) occupied by CSI reports and determining priorities of reporting CSIs.

A first example wireless communication method includes receiving, by a wireless device, one or more channel state information (CSI) report configurations, where each CSI report configuration of the one or more CSI report configurations configures one or more CSI reports. The method further includes determining, by the wireless device, a number of CSI processing units (CPUs) occupied by one or more CSI reports configured by a CSI report configuration of the one or more CSI report configurations. The method further includes processing, by the wireless device, one or more sets of CSIs based on a predefined rule related to the number of CPUs occupied by the one or more CSI reports.

A second example wireless communication method is based on the first example wireless communication method, where processing the one or more sets of CSIs based on the predefined rule includes determining a priority value of a CSI report included in the one or more CSI reports.

A third example wireless communication method includes sending, by a network device, one or more channel state information (CSI) report configurations, where each CSI report configuration of the one or more CSI report configurations configures one or more CSI reports. The method further includes determining, by the network device, a number of CSI processing units (CPUs) occupied by one or more CSI reports configured by a CSI report configuration of the one or more CSI report configurations. The method further includes receiving, by the network device, one or more sets of CSIs based on a predefined rule related to the number of CPUs occupied by the one or more CSI reports.

A fourth example wireless communication method is based on the third example wireless communication method, where receiving the one or more sets of CSIs based on the predefined rule includes determining a priority value of a CSI report included in the one or more CSI reports.

In yet another exemplary embodiment, a device that is configured or operable to perform the above-described methods is disclosed. The device may include a processor configured to implement the above-described methods.

In yet another exemplary embodiment, the above-described methods are embodied in the form of processor-executable code and stored in a non-transitory computer-readable storage medium. The code included in the computer readable storage medium when executed by a processor, causes the processor to implement the methods described in this patent document.

The above and other aspects and their implementations are described in greater detail in the drawings, the descriptions, and the claims.

### BRIEF DESCRIPTION OF THE DRAWINGS

FIG. 1 illustrates types of channel state information (CSI) reports.

FIG. 2 illustrates positions of signals during CSI reporting.

FIG. 3 is an exemplary flowchart for processing CSIs.

FIG. 4 is an exemplary flowchart for determining a priority value of a CSI report.

FIG. 5 is an exemplary flowchart for receiving CSIs.

FIG. 6 is an exemplary flowchart for receiving CSIs based on a priority value of a CSI report.

FIG. 7 illustrates an exemplary block diagram of a hardware platform that may be a part of a network device or a communication device.

FIG. 8 illustrates exemplary wireless communication including a Base Station (BS) and User Equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

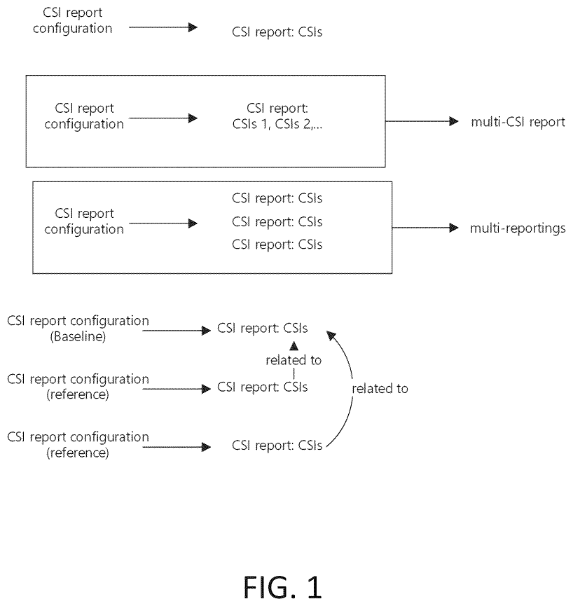

As shown in FIG. 1, channel state information (CSI) reports can be a single CSI report including a single set of CSIs (single-CSI), a single CSI report including multiple sets of CSIs (multi-CSI), or multiple CSI reports with each CSI report including a single set of CSIs (multi-reporting). Different types of CSI reports occupy different numbers of CSI processing units (CPUs). CSIs can be processed based on priorities. In some embodiments, the priorities are related to the occupied CPUs. This patent document presents methods to determine occupied CPUs and priorities. This patent document further presents methods to process CSIs.

Large-bandwidth and multi-antenna devices are used in 5G communication systems. The large amount of spatial elements causes a large power consumption.

To reduce the power consumption of gNB, one potential method is reducing the number of antennas or antenna ports. The channel will also be changed if the number of antennas changed. To help gNB obtain the channel states of different numbers of antennas, multiple channel state information (CSIs) with different antenna patterns are needed. The multiple CSIs with different antenna patterns may be obtained by a specific CSI report configuration type.

To calculate CSIs, one or more CSI processing units (CPUs) are occupied. The number of CPUs that will be occupied by the specific CSI report configuration type and how to allocate the CPUs need to be studied.

In this patent document, a method to allocate the CPUs is provided.

Channel state information (CSI) measurement: user equipment (UE) shall perform measurements based on CSI reference signal (CSI-RS) and may report corresponding report to gNB.

A UE can be configured with one or more CSI report configurations. Each CSI report configuration is configured by a CSI-ReportConfig signaling. The CSI-ReportConfig will associate with one or more CSI-RS resource settings by CSI-resourceConfigID. The CSI-RS resource setting is configured by CSI-ResourceConfig signaling.

The number of ports of a CSI-RS is configured by nrofPorts in CSI-ResourceMapping. CSI-ResourceMapping is associated with a NZP-CSI-RS-Resource. NZP-CSI-RS-Resource is associated with a NZP-CSI-RS-ResourceSet. A NZP-CSI-RS-ResourceSet is associated with a CSI-ResourceConfig. A CSI-ResourceConfig is associated with a CSI-ReportConfig. The nrofPorts can be one of the following: p1, p2, p4, p8, p12, p16, p24, p32.

The UE indicates the number of supported simultaneous CSI calculations N_{CPU} with parameter simultaneousCSI-ReportsPerCC in a component carrier, and simultaneous CSI-ReportsAllCC across all component carriers. If a UE supports N_{CPU} simultaneous CSI calculations, it is said to have N_{CPU} CSI processing units (CPUs) for processing CSI reports. If L CPUs are occupied for calculation of CSI reports in a given OFDM symbol, the UE has N_{CPU}−L unoccupied CPUs. If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority, where 0≤M≤N is the largest value such that

$${\sum }_{n = 0}^{M - 1} {O}_{CPU}^{( n )} \leq {N}_{CPU} - L$$

holds.

In other words, if UE needs to report N CSI reports and the N CSI reports occupied more than N_{CPU}, some low priority CSI reports may not need to be calculated. Therefore, the priority rules for different CSI report types are important.

In some embodiments, the predefined rule is: If N CSI reports start occupying their respective CPUs on the same OFDM symbol on which N_{CPU}−L CPUs are unoccupied, where each CSI report n=0, . . . , N−1 corresponds to

$${O}_{CPU}^{( n )} ,$$

the UE is not required to update the N−M requested CSI reports with lowest priority, where 0≤M≤N is the largest value such that

$${\sum }_{n = 0}^{M - 1} {O}_{CPU}^{( n )} \leq {N}_{CPU} - L$$

holds. Otherwise, the UE needs to update all the N CSI reports.

The first CSI report configuration includes at least one of the following:

A CSI report configuration is associated with one CSI-RS resource. UE uses part of or all of the ports associated with the CSI-RS resource for CSI report calculation and reports one CSI report with one set of CSIs.

A CSI report configuration is associated with one CSI-RS resource. UE uses part of or all of the ports associated with the CSI-RS resource for CSI report calculation and reports one CSI report with multiple sets of CSIs.

A CSI report configuration is associated with a CSI-RS resource configured with multiple antenna patterns. UE reports one CSI report according to one of the antenna patterns.

A CSI report configuration is associated with a CSI-RS resource configured with multiple antenna patterns. UE reports one CSI report with multiple sets of CSIs according to multiple of the antenna patterns.

A CSI report configuration is associated with a CSI-RS resource configured with multiple antenna patterns. UE reports multiple CSI reports according to multiple of the antenna patterns.

A CSI report configuration is associated with a CSI-RS resource. UE reports multiple CSI reports according to part of or all of the ports associated with the CSI-RS resource.

A CSI report configuration is associated with a CSI-RS resource and multiple PUCCH resource parameter sets. UE reports multiple CSI reports according to different PUCCH resource parameter sets. In other words, UE reports multiple CSI reports in different CSI reportings.

Multiple CSI report configurations associated with one CSI-RS resource, UE reports multiple CSI reports according to part of or all of the ports associated with the CSI-RS resource.

In some embodiments, the CSI-related quantities in the CSI report associated with all the ports of the CSI-RS resource is different from the CSI-related quantities in the CSI report associated with part of the ports of the CSI-RS resource. In some embodiments, the CSI-related quantities in the CSI report associated with part of the ports of the CSI-RS resource is a subset of the CSI-related quantities in the CSI report associated with all the ports of the CSI-RS resource.

For example, CSI report associated with all the ports of the CSI-RS resource includes at least one of CSI-RS resource indicator (CRI), rank indicator (RI), precoding matric indicator (PMI), channel quality indicator (CQI). CSI report associated with part of the ports of the CSI-RS resource includes RI.

In some embodiments, the RI, CQI, or PMI reported in the CSI report associated with part of the ports of the CSI-RS resource is a differential value based on the corresponding RI, CQI, or PMI values reported in the CSI report associated with all the ports of the CSI-RS resource.

In some embodiments, the multiple CSI report configurations include a baseline CSI report configuration and a reference CSI report configuration.

A CSI report configuration is associated with a CSI-RS resource and multiple PUCCH resource parameter sets. UE reports multiple CSI reports according to different PUCCH resource parameter sets. In other words, UE reports multiple CSI reports in different CSI reportings.

The PUCCH resource parameter sets include at least one of the following: periodicity and offset of a reporting configuration for periodic and semi-persistent CSI reports, a PUCCH resource list of a reporting configuration for CSI reported on PUCCH, a report slot offset list of a reporting configuration for CSI reported on PUSCH, or a reportConfigType.

In some embodiments, a CSI-RS resource is at least one of the following: a resource (e.g., configured by NZP-CSI-RS-Resource), a ResourceMapping, a resource set (e.g., configured by NZP-CSI-RS-ResourceSet), a resource setting (e.g., configured by CSI-ResourceConfig).

Antenna pattern includes at least one of the following: number of ports, port index indication, group indication, power offset, an index (e.g., a resource ID, a resource set ID, a resource setting ID), transmission configuration indicator (TCI), code division multiplexing (CDM), resource mapping, CDM group index, frequency domain resource, time domain resource. Antenna pattern being different means that at least one of the antenna patterns is different.

Power offset corresponds to powerControlOffset or powerControlOffsetSS. Number of ports means number of CSI-RS ports.

powerControlOffset: which is the assumed ratio of PDSCH (physical downlink shared channel) EPRE (energy per resource element) to NZP (non-zero power) CSI-RS EPRE when UE derives CSI feedback. The values of powerControlOffset are in the range of [−8, 15] dB with 1 dB step size.

powerControlOffsetSS: which is the assumed ratio of NZP CSI-RS EPRE to SS/PBCH (synchronization signal/physical broadcast channel) block EPRE.

In some embodiments, a CSI report configuration corresponds to a CSI-ReportConfig configured by RRC signaling.

A set of CSIs may include at least one of the following: CRI (CSI-RS Resource Indicator), RI (Rank Indicator), PMI (Precoding Matrix Indicator), LI (Layer Indicator), or CQI (Channel quality indicator). In some embodiments, each set of CSIs is obtained based on one antenna pattern or part of ports of a CSI-RS resource or all the ports of a CSI-RS resource.

In some embodiments, processing one or more CSI reports according to a predefined rule includes determining a priority of each CSI report.

Determine the priority of each CSI report.

In some embodiments, CSI reports are associated with a priority value Pri_{iCSI}(y, k, c, s)=2·N_{cells}·Mₛ·y+N_{cells}·Mₛ·k+Mₛ·c+s where
y=0 for aperiodic CSI reports to be carried on physical uplink shared channel (PUSCH), y=1 for semi-persistent CSI reports to be carried on PUSCH, y=2 for semi-persistent CSI reports to be carried on physical uplink control channel (PUCCH), and y=3 for periodic CSI reports to be carried on PUCCH;
k=0 for CSI reports carrying L1-RSRP (reference signals received power) or L1-SINR (signal interference and noise ratio) and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

A first CSI report is said to have priority over second CSI report if the associated value is lower for the first report than for the second report.

In some embodiments, the priority of a CSI report is determined based on a Pri value. The Pri value is determined according to at least one of the following: a time domain behavior type of reporting configuration (y), a CSI related quantities type to report (k), a serving cell index (c), a value of the higher layer parameter maxNrofServingCells (Ncells), a reportConfigID (s), a value of the higher layer parameter maxNrofCSI-ReportConfigurations (Ms), a CSI report type indicator (r), a multi-CSI indication (m), a number of CSI report indication (n), a multi-reporting indication, a number of PUCCH resource parameter sets, or a scaling factor (f).

In some embodiments, the Pri value is determined according to the following: y, k, c, Ncells, s, and Ms. The Pri value of a CSI report is determined according to at least one of the following:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

In some embodiments, different types of CSI reports correspond to different k values. For example, for a reference CSI report, k=1 or k=2. For a multi-CSI report, a multi-reporting, or a baseline CSI report, k=0 or k=1.

For example, k=0 for CSI reports carrying L1-RSRP (reference signals received power) or L1-SINR (signal interference and noise ratio), multi-CSI reports, multi-reportings, or baseline CSI reports, and k=1 for other CSI reports.

In some embodiments, the Pri value is determined according to the following: y, k, c, Ncells, s, and Ms. The Pri value of a CSI report is determined according to at least one of the following:

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s$$

In some embodiments, different types of CSI reports correspond to different y values. For example, y=1 for semi-persistent CSI reports to be carried on PUSCH, multi-CSI reports, multi-reportings, or baseline CSI reports. For another example, for a reference CSI report, y=2, y=3, or y=4. For a multi-CSI report, a multi-reporting, or a baseline CSI report, y=0, y=1, or y=2.

For example, y=0 for aperiodic CSI reports to be carried on physical uplink shared channel (PUSCH), CSI reports carrying L1-SINR (signal interference and noise ratio), multi-CSI reports, multi-reportings, or baseline CSI reports, y=1 for semi-persistent CSI reports to be carried on PUSCH or reference CSI reports, y=2 for semi-persistent CSI reports to be carried on physical uplink control channel (PUCCH), and y=3 for periodic CSI reports to be carried on PUCCH.

In some embodiments, a CSI report configuration configures multiple CSI reports. The multiple CSI reports include a baseline CSI report and a reference CSI report.

The CSI report type indicator is a value about whether a CSI report is a third CSI report or a fourth CSI report. For example, the CSI report type indicator is 1 if the CSI report is a fourth CSI report. Otherwise, the CSI report type indicator is 0. For another example, the CSI report type indicator is 0 if the CSI report is a third CSI report, and the CSI report type indicator is 1 if the CSI report is a fourth CSI report.

In some embodiments, a fourth CSI report means the CSIs (e.g., at least one of RI, CQI, or PMI) are in reference to (or according to) the corresponding CSIs in another CSI report (e.g., third CSI report). In some embodiments, a fourth CSI report corresponds to a reference CSI report.

In some embodiments, a fourth CSI report means the CSIs (e.g., at least one of RI, CQI, or PMI) reported in the fourth CSI report is a differential value based on the CSIs (e.g., at least one of RI, CQI, or PMI) reported in a third CSI report. In some embodiments, a third CSI report corresponds to a baseline CSI report.

In some embodiments, baseline CSI reports and reference CSI reports are configured in one CSI report configuration. In some embodiments, baseline CSI reports and reference CSI reports are configured in different CSI report configurations.

In some embodiments, whether or not a CSI report is a fourth report is configured by a higher layer signaling.

### II. Embodiment 1

The Pri value is determined according to the following: y, k, c, Ncells, s, Ms, r. The Pri value of a CSI report is determined according to at least one of the following:

$$Pri ( y , k , c , s , r ) = {r}_{1} \cdot 2 \cdot {N}_{cells} \cdot {M}_{s} \cdot y + {r}_{2} \cdot {N}_{cells} \cdot {M}_{s} \cdot k + {r}_{3} \cdot {M}_{s} \cdot c + {r}_{4} \cdot s + {r}_{5} ,$$

In some embodiments, the values of r, r1, r2, r3, r4 and r5 are non-negative. In some embodiments, r1, r2, r3, r4 can exist or not exist. The value of at least one of r1, r2, r3, r4 can be 1, the same as r, or the same as a scaling factor (f). r5 can exist or not exist. The value of r5 can be 0 or the same as r. r is CSI report type indicator.

For example, the Pri value of a CSI report is determined according to at least one of the following:

$$Pri ( y , k , c , s , r ) = r \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , r ) = r \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , r ) = r \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , r ) = 2 \cdot {N}_{cells} \cdot {M}_{s} \cdot y + {N}_{cells} \cdot {M}_{s} \cdot k + r \cdot ( {M}_{s} \cdot c + s ) ,$$

$$Pri ( y , k , c , s , r ) = 2 \cdot {N}_{cells} \cdot {M}_{s} \cdot y + r \cdot ( {N}_{cells} \cdot {M}_{s} \cdot k + {M}_{s} \cdot c + s ) ,$$

$$Pri ( y , k , c , s , r ) = 2 \cdot {N}_{cells} \cdot {M}_{s} \cdot y \cdot r + {N}_{cells} \cdot {M}_{s} \cdot k + {M}_{s} \cdot c + s ,$$

$$Pri ( y , k , c , s , r ) = 2 \cdot {N}_{cells} \cdot {M}_{s} \cdot y + {N}_{cells} \cdot {M}_{s} \cdot k \cdot r + {M}_{s} \cdot c + s ,$$

$$Pri ( y , k , c , s , r ) = 2 \cdot {N}_{cells} \cdot {M}_{s} \cdot y + {N}_{cells} \cdot {M}_{s} \cdot k + {M}_{s} \cdot c \cdot r + s ,$$

$$Pri ( y , k , c , s , r ) = 2 \cdot {N}_{cells} \cdot {M}_{s} \cdot y + {N}_{cells} \cdot {M}_{s} \cdot k + {M}_{s} \cdot c + s \cdot r , or$$

$$Pri ( y , k , c , s , r ) = 2 \cdot {N}_{cells} \cdot {M}_{s} \cdot y + {N}_{cells} \cdot {M}_{s} \cdot k + {M}_{s} \cdot c + s + r$$

The multi-CSI indication is a value about whether a CSI report is a multi-CSI report configuration. For example, the multi-CSI indication is 0 if the CSI report is a multi-CSI report configuration. Otherwise, the multi-CSI indication is 1. For another example, the multi-CSI indication is 1 if the CSI report is a multi-CSI report configuration. Otherwise, the multi-CSI indication is 0.

In some embodiments, multi-CSI report configuration means UE reports multiple sets of CSI in one CSI report.

In some embodiments, multi-CSI report configuration means UE can report one or more sets of CSI in one CSI report.

In some embodiments, whether or not a CSI report is a multi-CSI report configuration is according to a higher layer signaling. In other words, a higher layer signaling indicates whether or not a CSI report is a multi-CSI report configuration. In some embodiments, the higher layer signaling is configured in CSI-ReportConfig.

### III. Embodiment 2

The Pri value is determined according to the following: y, k, c, Ncells, s, Ms, and m. The Pri value of a CSI report is determined according to at least one of the following:

$$Pri ( y , k , c , s , m ) = {m}_{1} \cdot 2 \cdot {N}_{cells} \cdot {M}_{s} \cdot y + {m}_{2} \cdot {N}_{cells} \cdot {M}_{s} \cdot k + {m}_{3} \cdot {M}_{s} \cdot c + {m}_{4} \cdot s + {m}_{5}$$

In some embodiments, the values of m, m1, m2, m3, m4 and m5 are non-negative. In some embodiments, m1, m2, m3, m4 can exist or not exist. The value of m1, m2, m3, m4 can be 1, the same as m, or the same as a scaling factor (f). m5 can exist or not exist. The value of m5 can be 0 or the same as m. The scaling factor can be different values for different CSI reports. For example, the scaling factor is 0 if the CSI report is a multi-CSI report and is 1 if the CSI report is not a multi-CSI report. m is multi-CSI indication.

For example,

The Pri value of a CSI report is determined according to at least one of the following:

$$Pri ( y , k , c , s , m ) = m \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , m ) = m \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , m ) = m \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , m ) = 2 \cdot {N}_{cells} \cdot {M}_{s} \cdot y + {N}_{cells} \cdot {M}_{s} \cdot k + m \cdot ( {M}_{s} \cdot c + s ) ,$$

$$Pri ( y , k , c , s , m ) = 2 \cdot {N}_{cells} \cdot {M}_{s} \cdot y + m \cdot ( {N}_{cells} \cdot {M}_{s} \cdot k + {M}_{s} \cdot c + s ) ,$$

$$Pri ( y , k , c , s , m ) = 2 \cdot {N}_{cells} \cdot {M}_{s} \cdot y \cdot m + {N}_{cells} \cdot {M}_{s} \cdot k + {M}_{s} \cdot c + s ,$$

$$Pri ( y , k , c , s , m ) = 2 \cdot {N}_{cells} \cdot {M}_{s} \cdot y + {N}_{cells} \cdot {M}_{s} \cdot k \cdot m + {M}_{s} \cdot c + s ,$$

$$Pri ( y , k , c , s , m ) = 2 \cdot {N}_{cells} \cdot {M}_{s} \cdot y + {N}_{cells} \cdot {M}_{s} \cdot k + {M}_{s} \cdot c \cdot m + s ,$$

$$Pri ( y , k , c , s , m ) = 2 \cdot {N}_{cells} \cdot {M}_{s} \cdot y + {N}_{cells} \cdot {M}_{s} \cdot k + {M}_{s} \cdot c + s \cdot m , or$$

$$Pri ( y , k , c , s , m ) = 2 \cdot {N}_{cells} \cdot {M}_{s} \cdot y + {N}_{cells} \cdot {M}_{s} \cdot k + {M}_{s} \cdot c + s + m$$

In some embodiments, a number of CSI set indication is a value about whether or not more than one set of CSIs are reported in one report according to the CSI report. For example, the number of CSI set indication is 0 if more than one set of CSIs are reported in one report. Otherwise, the number of CSI set indication is 1. For another example, the number of CSI set indication is 1 if more than one set of CSIs are reported in one report. Otherwise, the number of CSI set indication is 0.

### IV. Embodiment 3

The Pri value is determined according to the following: y, k, c, Ncells, s, Ms, n. The Pri value of a CSI report is determined according to at least one of the following:

$$Pri ( y , k , c , s , n ) = n \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , n ) = n \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , n ) = n \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , n ) = 2 \cdot {N}_{cells} \cdot {M}_{s} \cdot y + {N}_{cells} \cdot {M}_{s} \cdot k + n \cdot ( {M}_{s} \cdot c + s ) ,$$

$$Pri ( y , k , c , s , n ) = 2 \cdot {N}_{cells} \cdot {M}_{s} \cdot y + n \cdot ( {N}_{cells} \cdot {M}_{s} \cdot k + {M}_{s} \cdot c + s ) ,$$

$$Pri ( y , k , c , s , n ) = 2 \cdot {N}_{cells} \cdot {M}_{s} \cdot y \cdot n + {N}_{cells} \cdot {M}_{s} \cdot k + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k \cdot n + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c \cdot n + s ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c + s \cdot n , or$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c + s + n$$

In some embodiments, the value of n is non-negative. In some embodiments, a number of CSI set indication is a value about the number of CSI sets reported in one report according to the CSI report. For example, the number of CSI set indication is the same as the number of CSI sets reported in one report. For another example, the number of CSI set indication is the same as the number of CSI sets reported in one report subtracted by 1. For another example, the number of CSI set indication is the same as the number of antenna patterns configured or selected for a CSI report configuration.

The number of CSI sets reported in one report is configured by a RRC signaling, indicates by a downlink control information (DCI), indicated by a media access control (MAC) control element (CE), or derived according to the number of antenna patterns configured or selected for a CSI report configuration.

### V. Embodiment 4

The Pri value is determined according to the following: y, k, c, Ncells, s, Ms, and n. The Pri value of a CSI report is determined according to at least one of the following:

$$Pri ( y , k , c , s , n ) = {n}_{1} \cdot 2 \cdot {N}_{cells} \cdot {M}_{s} \cdot y + {n}_{2} \cdot {N}_{cells} \cdot {M}_{s} \cdot k + {n}_{3} \cdot {M}_{s} \cdot c + {n}_{4} \cdot s + {n}_{5}$$

In some embodiments, the values of n, n1, n2, n3, n4 and n5 are non-negative. In some embodiments, n1, n2, n3, n4 can exist or not exist. The value of n1, n2, n3, n4 can be 1, the same as n, or the same as a scaling factor (f). n5 can exist or not exist. The value of n5 can be 0 or the same as n. The scaling factor can be different values for different CSI reports. For example, the scaling factor is 0 if the CSI report is a multi-CSI report and is 1 if the CSI report is not a multi-CSI report. n is the number of CSI sets indication.

For example,

$$Pri ( y , k , c , s , n ) = n \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , n ) = n \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , n ) = n \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , n ) = function [ ( 2 \cdot {N}_{cells} \cdot {M}_{s} \cdot y + {N}_{cells} \cdot {M}_{s} \cdot k ) / n ] + {M}_{s} \cdot c + s ,$$

$$Pri ( y , k , c , s , n ) = function [ \frac{2 \cdot {N}_{cells} \cdot {M}_{s} \cdot y + {N}_{cells} \cdot {M}_{s} \cdot k + {M}_{s} \cdot c}{n} ] + s ,$$

$$Pri ( y , k , c , s , n ) = function [ ( 2 \cdot {N}_{cells} \cdot {M}_{s} \cdot y + {N}_{cells} \cdot {M}_{s} \cdot k + {M}_{s} \cdot c + s ) ] / n ,$$

$$Pri ( y , k , c , s , n ) = 2 \cdot {N}_{cells} \cdot {M}_{s} \cdot y + {N}_{cells} \cdot {M}_{s} \cdot k + n \cdot ( {M}_{s} \cdot c + s ) ,$$

$$Pri ( y , k , c , s , n ) = 2 \cdot {N}_{cells} \cdot {M}_{s} \cdot y + n \cdot ( {N}_{cells} \cdot {M}_{s} \cdot k + {M}_{s} \cdot c + s ) ,$$

$$Pri ( y , k , c , s , n ) = 2 \cdot {N}_{cells} \cdot {M}_{s} \cdot y \cdot n + {N}_{cells} \cdot {M}_{s} \cdot k + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k \cdot n + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k + function [ ( {M}_{s} \cdot c + s ) / n ] ,$$

$$Pri ( y , k , c , s , n ) = 2 \cdot {N}_{cells} \cdot {M}_{s} \cdot y + function [ ( {N}_{cells} \cdot {M}_{s} \cdot k + {M}_{s} \cdot c + s ) / n ] ,$$

$$Pri ( y , k , c , s , n ) = f unction [ 2 \cdot {N}_{cells} \cdot {M}_{s} \cdot y / n ] + {N}_{cells} \cdot {M}_{s} \cdot k + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k \cdot n + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c \cdot n + s ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c + s \cdot n ,$$

$$Pri ( y , k , c , s , n ) = 2 \cdot {N}_{cells} \cdot {M}_{s} \cdot y + function [ {N}_{cells} \cdot {M}_{s} \cdot k / n ] + {M}_{s} \cdot c + s ,$$

$$Pri ( y , k , c , s , n ) = 2 \cdot {N}_{cells} \cdot {M}_{s} \cdot y + {N}_{cells} \cdot {M}_{s} \cdot k + function [ {M}_{s} \cdot \frac{c}{n} ] + s ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c + function [ s / n ] ,$$

$$Pri ( y , k , c , s , n ) = 2 \cdot {N}_{cells} \cdot {M}_{s} \cdot y + {N}_{cells} \cdot {M}_{s} \cdot k + {M}_{s} \cdot c + s + n , or$$

$$Pri ( y , k , c , s , n ) = function [ 2 \cdot {N}_{cells} \cdot {M}_{s} \cdot y + {N}_{cells} \cdot {M}_{s} \cdot k + {M}_{s} \cdot c + s - n ]$$

In some embodiments, Function [X] means to keep the original value or round up or round down the original value.

In some embodiments, function [X] means to keep the original value if X is greater than or equal to 0, and to set the value to 0 if X is less than 0.

### VI. Embodiment 5

The Pri value is determined according to the following: y, k, c, Ncells, s, Ms, m, n. The Pri value of a CSI report is determined according to at least one of the following:

$$Pri ( y , k , c , s , m , n ) = m \cdot ( 2 \cdot {N}_{cells} \cdot {M}_{s} \cdot y + {N}_{cells} \cdot {M}_{s} \cdot k ) + {M}_{s} \cdot c + s + n ,$$

$$Pri ( y , k , c , s , m , n ) = m \cdot ( 2 \cdot {N}_{cells} \cdot {M}_{s} \cdot y + {N}_{cells} \cdot {M}_{s} \cdot k + {M}_{s} \cdot c ) + s + n ,$$

$$Pri ( y , k , c , s , m , n ) = m \cdot ( 2 \cdot {N}_{cells} \cdot {M}_{s} \cdot y + {N}_{cells} \cdot {M}_{s} \cdot k + {M}_{s} \cdot c + s ) + n ,$$

$$Pri ( y , k , c , s , m , n ) = 2 \cdot {N}_{cells} \cdot {M}_{s} \cdot y + {N}_{cells} \cdot {M}_{s} \cdot k + m \cdot ( {M}_{s} \cdot c + s ) + n ,$$

$$Pri ( y , k , c , s , m , n ) = 2 \cdot {N}_{cells} \cdot {M}_{s} \cdot y + m \cdot ( {N}_{cells} \cdot {M}_{s} \cdot k + {M}_{s} \cdot c + s ) + n ,$$

$$Pri ( y , k , c , s , m , n ) = 2 \cdot {N}_{cells} \cdot {M}_{s} \cdot y \cdot m + {N}_{cells} \cdot {M}_{s} \cdot k + {M}_{s} \cdot c + s + n ,$$

$$Pri ( y , k , c , s , m , n ) = 2 \cdot {N}_{cells} \cdot {M}_{s} \cdot y + {N}_{cells} \cdot {M}_{s} \cdot k \cdot m + {M}_{s} \cdot c + s + n ,$$

$$Pri ( y , k , c , s , m , n ) = 2 \cdot {N}_{cells} \cdot {M}_{s} \cdot y + {N}_{cells} \cdot {M}_{s} \cdot k + {M}_{s} \cdot c \cdot m + s + n ,$$

$$Pri ( y , k , c , s , m , n ) = 2 \cdot {N}_{cells} \cdot {M}_{s} \cdot y + {N}_{cells} \cdot {M}_{s} \cdot k + {M}_{s} \cdot c + s \cdot m + n ,$$

$$Pri ( y , k , c , s , m , n ) = 2 \cdot {N}_{cells} \cdot {M}_{s} \cdot y + {N}_{cells} \cdot {M}_{s} \cdot k + {M}_{s} \cdot c + s + m + n$$

A multi-reporting indication (p) is a value about whether a UE reports multiple CSI reports of the first CSI report configuration. For example, p=0 if a CSI report configuration does not need to report multiple CSI reports in different PUCCH resources, and p=1 if a CSI report configuration needs to report multiple CSI reports in different PUCCH resources. For another example, p=1 if a CSI report configuration does not need to report multiple CSI reports in different PUCCH resources, and p=0 if a CSI report configuration needs to report multiple CSI reports in different PUCCH resources. A multi-reporting indication (p) is a value about the number of CSI reportings configured in a CSI report configuration. In some embodiments, the number of CSI reportings configured in a CSI report configuration is the same as the number of PUCCH resource parameter sets configured in the CSI report configuration.

### VII. Embodiment 6

The Pri value is determined according to the following: y, k, c, Ncells, s, Ms, and p. The Pri value of the CSI reports configured in one CSI report configuration are determined according to at least one of the following:

$$Pri ( y , k , c , s , p ) = {p}_{1} \cdot 2 \cdot {N}_{cells} \cdot {M}_{s} \cdot y + {p}_{2} \cdot {N}_{cells} \cdot {M}_{s} \cdot k + {p}_{3} \cdot {M}_{s} \cdot c + {p}_{4} \cdot s + {p}_{5}$$

In some embodiments, the values of p, p1, p2, p3, p4 and p5 are non-negative. In some embodiments, p1, p2, p3, p4 can exist or not exist. The value of p1, p2, p3, p4 can be 1, the same as p, or the same as a scaling factor (f). p5 can exist or not exist. The value of p5 can be 0 or the same as p.

For example:

$$Pri ( y , k , c , s , p ) = p \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , p ) = p \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , p ) = p \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , p ) = 2 \cdot {N}_{cells} \cdot {M}_{s} \cdot y + {N}_{cells} \cdot {M}_{s} \cdot k + p \cdot ( {M}_{s} \cdot c + s ) ,$$

$$Pri ( y , k , c , s , p ) = 2 \cdot {N}_{cells} \cdot {M}_{s} \cdot y + p \cdot ( {N}_{cells} \cdot {M}_{s} \cdot k + {M}_{s} \cdot c + s ) ,$$

$$Pri ( y , k , c , s , p ) = 2 \cdot {N}_{cells} \cdot {M}_{s} \cdot y \cdot p + {N}_{cells} \cdot {M}_{s} \cdot k + {M}_{s} \cdot c + s ,$$

$$Pri ( y , k , c , s , p ) = 2 \cdot {N}_{cells} \cdot {M}_{s} \cdot y + {N}_{cells} \cdot {M}_{s} \cdot k \cdot p + {M}_{s} \cdot c + s ,$$

$$Pri ( y , k , c , s , p ) = 2 \cdot {N}_{cells} \cdot {M}_{s} \cdot y + {N}_{cells} \cdot {M}_{s} \cdot k + {M}_{s} \cdot c \cdot p + s ,$$

$$Pri ( y , k , c , s , p ) = 2 \cdot {N}_{cells} \cdot {M}_{s} \cdot y + {N}_{cells} \cdot {M}_{s} \cdot k + {M}_{s} \cdot c + s \cdot p ,$$

$$Pri ( y , k , c , s , p ) = 2 \cdot {N}_{cells} \cdot {M}_{s} \cdot y + {N}_{cells} \cdot {M}_{s} \cdot k + {M}_{s} \cdot c + s + p$$

In some embodiments, Pri value is determined by at least the number of PUCCH resource parameter sets configured in CSI report configurations. A scaling factor f is used. For example, f=1 if a CSI report configuration is not configured with more than one PUCCH resource parameter sets, and f=0 if a CSI report configuration is configured with multiple PUCCH resource parameter sets. For another example, f=0 if a CSI report configuration is not configured with more than one PUCCH resource parameter sets, and f=1 if a CSI report configuration is configured with multiple PUCCH resource parameter sets. In some embodiments, the priority of the CSI reports configured in one CSI report configuration are the same.

### VIII. Embodiment 7

The Pri value is determined according to the following: y, k, c, Ncells, s, Ms, and Npu. Npu is a value about the number of PUCCH resource parameter sets configured in CSI report configurations. Npu is non-negative. For example, Npu=1 if a CSI report configuration is not configured with more than one PUCCH resource parameter set, and Npu=0 if a CSI report configuration is configured with multiple PUCCH resource parameter sets. For another example, Npu=0 if a CSI report configuration is not configured with more than one PUCCH resource parameter set, and Npu=1 if a CSI report configuration is configured with multiple PUCCH resource parameter sets. For another example, Npu is equal to the number of PUCCH resource parameter sets configured in CSI report configurations. The Pri value of a CSI report is determined according to at least one of the following:

$$Pri ( y , k , c , s , Npu ) = Npu \cdot ( 2 \cdot {N}_{cells} \cdot {M}_{s} \cdot y + {N}_{cells} \cdot {M}_{s} \cdot k ) + {M}_{s} \cdot c + s ,$$

$$Pri ( y , k , c , s , Npu ) = Npu \cdot ( 2 \cdot {N}_{cells} \cdot {M}_{s} \cdot y + {N}_{cells} \cdot {M}_{s} \cdot k + {M}_{s} \cdot c ) + s ,$$

$$Pri ( y , k , c , s , Npu ) = Npu \cdot ( 2 \cdot {N}_{cells} \cdot {M}_{s} \cdot y + {N}_{cells} \cdot {M}_{s} \cdot k + {M}_{s} \cdot c + s ) ,$$

$$Pri ( y , k , c , s , Npu ) = 2 \cdot {N}_{cells} \cdot {M}_{s} \cdot y + {N}_{cells} \cdot {M}_{s} \cdot k + Npu \cdot ( {M}_{s} \cdot c + s ) ,$$

$$Pri ( y , k , c , s , Npu ) = 2 \cdot {N}_{cells} \cdot {M}_{s} \cdot y + Npu \cdot ( {N}_{cells} \cdot {M}_{s} \cdot k + {M}_{s} \cdot c + s ) ,$$

$$Pri ( y , k , c , s , Npu ) = 2 \cdot {N}_{cells} \cdot {M}_{s} \cdot y \cdot Npu + {N}_{cells} \cdot {M}_{s} \cdot k + {M}_{s} \cdot c + s ,$$

$$Pri ( y , k , c , s , Npu ) = 2 \cdot {N}_{cells} \cdot {M}_{s} \cdot y + {N}_{cells} \cdot {M}_{s} \cdot k \cdot Npu + {M}_{s} \cdot c + s ,$$

$$Pri ( y , k , c , s , Npu ) = 2 \cdot {N}_{cells} \cdot {M}_{s} \cdot y + {N}_{cells} \cdot {M}_{s} \cdot k + {M}_{s} \cdot c \cdot Npu + s ,$$

$$Pri ( y , k , c , s , Npu ) = 2 \cdot {N}_{cells} \cdot {M}_{s} \cdot y + {N}_{cells} \cdot {M}_{s} \cdot k + {M}_{s} \cdot c + s \cdot Npu ,$$

$$Pri ( y , k , c , s , Npu ) = 2 \cdot {N}_{cells} \cdot {M}_{s} \cdot y + {N}_{cells} \cdot {M}_{s} \cdot k + {M}_{s} \cdot c + s + Npu$$

### IX. Embodiment 8

The Pri value is determined according to the following: y, k, c, Ncells, s, Ms, f, and one of {Npu, m, n, r}. The Pri value of a CSI report is determined according to at least one of the following:

$$Pri ( y , k , c , s , f ) = f \cdot ( 2 \cdot {N}_{cells} \cdot {M}_{s} \cdot y + {N}_{cells} \cdot {M}_{s} \cdot k ) + {M}_{s} \cdot c + s + choice \{ Npu , m , n , r \} ,$$

$$Pri ( y , k , c , s , f ) = f \cdot ( 2 \cdot {N}_{cells} \cdot {M}_{s} \cdot y + {N}_{cells} \cdot {M}_{s} \cdot k + {M}_{s} \cdot c ) + s + choice \{ Npu , m , n , r \} ,$$

$$Pri ( y , k , c , s , f ) = f \cdot ( 2 \cdot {N}_{cells} \cdot {M}_{s} \cdot y + {N}_{cells} \cdot {M}_{s} \cdot k + {M}_{s} \cdot c + s ) + choice \{ Npu , m , n , r \} ,$$

$$Pri ( y , k , c , s , f ) = 2 \cdot {N}_{cells} \cdot {M}_{s} \cdot y + {N}_{cells} \cdot {M}_{s} \cdot k + f \cdot ( {M}_{s} \cdot c + s ) + choice \{ Npu , m , n , r \} ,$$

$$Pri ( y , k , c , s , f ) = 2 \cdot {N}_{cells} \cdot {M}_{s} \cdot y + f \cdot ( {N}_{cells} \cdot {M}_{s} \cdot k + {M}_{s} \cdot c + s ) + choice \{ Npu , m , n , r \} ,$$

$$Pri ( y , k , c , s , f ) = 2 \cdot {N}_{cells} \cdot {M}_{s} \cdot y \cdot f + {N}_{cells} \cdot {M}_{s} \cdot k + {M}_{s} \cdot c + s + choice \{ Npu , m , n , r \} ,$$

$$Pri ( y , k , c , s , f ) = 2 \cdot {N}_{cells} \cdot {M}_{s} \cdot y + {N}_{cells} \cdot {M}_{s} \cdot k \cdot f + {M}_{s} \cdot c + s + choice \{ Npu , m , n , r \} ,$$

$$Pri ( y , k , c , s , f ) = 2 \cdot {N}_{cells} \cdot {M}_{s} \cdot y + {N}_{cells} \cdot {M}_{s} \cdot k + {M}_{s} \cdot c \cdot f + s + choice \{ Npu , m , n , r \} ,$$

$$Pri ( y , k , c , s , f ) = 2 \cdot {N}_{cells} \cdot {M}_{s} \cdot y + {N}_{cells} \cdot {M}_{s} \cdot k + {M}_{s} \cdot c + s \cdot f + choice \{ Npu , m , n , r \} ,$$

Choice{Npu, m, n, r} means one of {Npu, m, n, r}.

In some embodiments, the priority of multi-CSI report is the highest.

In some embodiments, the priority of multi-reporting is the highest.

Multi-reporting is a CSI report configuration configured with multiple PUCCH resource parameter sets.

Multi-reporting is a CSI report configuration for which UE needs to report multiple CSI reports according to the same or different PUCCH resource parameter sets.

In some embodiments, if the occupied CPUs of a multi-CSI report is less than or equal to N_{CPU}, the priority of the multi-CSI report is the highest.

In some embodiments, if the occupied CPUs of a multi-CSI report is less than or equal to N_{CPU}−L, the priority of the multi-CSI report is the highest. N_{CPU}−L means the unoccupied CPUs when the CSI reports start occupying the respective CPUs on the OFDM symbol.

In some embodiments, if the occupied CPUs of a multi-CSI report is less than or equal to N_{CPU}, the priority of the multi-CSI report is the highest. Otherwise, the priority of the multi-CSI report is the lowest.

In some embodiments, if the occupied CPUs of a multi-CSI report is less than or equal to N_{CPU}−L, the priority of the multi-CSI report is the highest. Otherwise, the priority of the multi-CSI report is the lowest.

In some embodiments, if the occupied CPUs of a multi-CSI report is less than or equal to N_{CPU}, and greater than N_{CPU}−L, the CSI reports that occupy the L CPUs are stopped. And the priority of the multi-CSI report is the highest.

In some embodiments, if the occupied CPUs of a multi-CSI report is less than or equal to N_{CPU}, the priority of the multi-CSI report is the highest. Otherwise, the priority of the multi-CSI report is determined by Pri value.

In some embodiments, if the occupied CPUs of a multi-CSI report is less than or equal to N_{CPU}−L, the priority of the multi-CSI report is the highest. Otherwise, the priority of the multi-CSI report is determined by Pri value.

In some embodiments, the priority of a multi-CSI report is the lowest.

In some embodiments, the priority of multi-reporting is the lowest.

In some embodiments, the priority of multi-reporting is the highest.

In some embodiments, if the occupied CPUs of a multi-reporting is less than or equal to N_{CPU}−L, the priority of the multi-reporting is the highest. Otherwise, the priority of the multi-reporting is determined by Pri value.

In some embodiments, if the occupied CPUs of a multi-reporting is less than or equal to N_{CPU}, the priority of the multi-reporting is the highest.

In some embodiments, if the occupied CPUs of a multi-reporting is less than or equal to N_{CPU}−L, the priority of the multi-reporting is the highest.

In some embodiments, the priority of a baseline CSI report is the highest.

In some embodiments, the priority of a baseline CSI report (third CSI report) is higher than the priority of a reference CSI report (fourth CSI report).

### X. Embodiment 9

Determining the number of CPUs occupied by the CSI reports configured in a first CSI report configuration.

In some embodiments, for a CSI report configuration associated with one CSI-RS resource, UE uses part of or all of the ports associated with the CSI-RS resource for CSI report calculation and reports one CSI report with one set of CSIs, or for a CSI report configuration associated with a CSI-RS resource configured with multiple antenna patterns, UE reports one CSI report with one set of CSIs according to one of the antenna patterns, the number of CPUs occupied by the CSI report configuration (O_{CPU}) is at least one of the following:

O_{CPU}=Ky, Ky is the number of active CSI-RS resources for channel measurement.

O_{CPU}=1.

O_{CPU}=1, if UE uses part of the ports associated with the CSI-RS resource for CSI report calculation.

O_{CPU}=0, if UE uses part of the ports associated with the CSI-RS resource for CSI report calculation.

O_{CPU}=Ky, Ky is the number of active CSI-RS resources for channel measurement, if UE uses all the ports associated with the CSI-RS resource for CSI report calculation.

In some embodiments, for a CSI report with CSI-ReportConfig with higher layer parameter reportQuantity set to ‘cri-RI-PMI-CQI,’ ‘cri-RI-i1,’ ‘cri-RI-i1-CQI,’ ‘cri-RI-CQI,’ or ‘cri-RI-LI-PMI-CQI,’ and the CSI report is not a second type CSI report, the O_{CPU}=Ks, Ks is the number of active CSI-RS resources for channel measurement.

The second type CSI report includes at least one of the following:

max{μPDCCH, μCSI-RS, μUL}≤3, and a CSI report is a periodically triggered without transmitting a PUSCH with either transport block or hybrid automatic repeat request acknowledgement (HARQ-ACK) or both when L=0 CPUs are occupied, where the CSI corresponds to a single CSI with wideband frequency-granularity and to at most 4 CSI-RS ports in a single resource without CRI report and where codebookType is set to ‘typeI-SinglePanel’ or where reportQuantity is set to ‘cri-RI-CQI.’

a CSI-ReportConfig is configured with codebookType set to ‘typeI-SinglePanel’ and the corresponding CSI-RS Resource Set for channel measurement is configured with two Resource Groups and N Resource Pairs, O_{CPU}=X·N+M, where X is the number of CPUs occupied by a pair of CMRs subject to UE capability.

In some embodiments, for a CSI report configuration associated with one CSI-RS resource, and UE uses part of or all of the ports associated with the CSI-RS resource for CSI report calculation and reports multiple CSI sets of CSIs, or for a CSI report configuration associated with a CSI-RS resource configured with multiple antenna patterns, UE reports multiple sets of CSIs according to multiple of the antenna patterns, or for a CSI report configuration where UE can report more than one set of CSIs in one report, or for a CSI report configuration where UE can report more than one CSI report, the number of CPUs occupied by the CSI report configuration (O_{CPU}) is at least one of the following:

O_{CPU}=Ky, Ky is the number of active CSI-RS resources for channel measurement.

O_{CPU}=Kp, Kp is the number of selected antenna patterns for channel measurement.

O_{CPU}=Ky+n−1, Ky is the number of active CSI-RS resources for channel measurement, n is the number value.

O_{CPU}=Ky*n, Ky is the number of active CSI-RS resources for channel measurement, n is the number value.

O_{CPU}=Ks+n−1, Ks is the number of CSI-RS resources in the CSI-RS resource set for channel measurement, n is the number value.

O_{CPU}=Ks*n, Ks is the number of CSI-RS resources in the CSI-RS resource set for channel measurement, n is the number value.

O_{CPU}=n, n is number of CSI sets reported in one report, or n is the number of selected antenna patterns for channel measurement, or n is number of CSI reports in a multi-reporting of one CSI report configuration.

O_{CPU}=u*n, u is a scaling factor, n is the number of CSI sets reported in one report, or n is the number of selected antenna patterns for channel measurement, or n is the number of CSI reports for one CSI report configuration.

O_{CPU}=u*Kp, u is a scaling factor, Kp is the number of selected antenna patterns for channel measurement.

O_{CPU}=Ky*u, Ky is the number of active CSI-RS resources for channel measurement, u is a scaling factor.

O_{CPU}=Kp*u, Kp is the number of selected antenna patterns for channel measurement, u is a scaling factor.

O_{CPU}=Kp*Ky*u, Kp is the number of selected antenna patterns for channel measurement, u is a scaling factor, Ky is the number of active CSI-RS resources for channel measurement.

O_{CPU}=Kp*Ks*u, Ks is the number of CSI-RS resources in a pattern for channel measurement, u is a scaling factor, Ky is the number of active CSI-RS resources for channel measurement.

In some embodiments, u is a scaling factor for multi-CSI report.

In some embodiments, u is a predefined value.

In some embodiments, u is a value reported by UE (e.g., UE capability). For example, u is a value greater than 0 and less than or equal to 1. u can be 1, 0.75, 0.5, 0.25, 0.3, 0.1, or 0.2.

In some embodiments, u is a value indicated by RRC or MAC CE or DCI.

In some embodiments, the value indicated by RRC or MAC CE or DCI should not exceed the UE capability.

O_{CPU}=Ks*u, Ks is the number of CSI-RS resources in the CSI-RS resource set for channel measurement, u is a scaling factor.

O_{CPU}=Ky*u*n, Ky is the number of active CSI-RS resources for channel measurement, u is a scaling factor for multi-CSI report, n is number value.

In some embodiments, u has different values for different numbers of CSI sets reported in one report.

O_{CPU}=Ks*u*n, Ks is the number of CSI-RS resources in the CSI-RS resource set for channel measurement, u is a scaling factor for multi-CSI report, n is number value.

O_{CPU}=Ky+u*(n−1), Ky is the number of active CSI-RS resources for channel measurement, u is a scaling factor for multi-CSI report, n is number value.

O_{CPU}=Ky+u*Ky*(n−1), Ky is the number of active CSI-RS resources for channel measurement, u is a scaling factor for multi-CSI report, n is number value.

O_{CPU}=Ks+u*(n−1), Ks is the number of CSI-RS resources in the CSI-RS resource set for channel measurement, u is a scaling factor for multi-CSI report, n is number value.

O_{CPU}=Ks+u*Ks*(n−1), Ks is the number of CSI-RS resources in the CSI-RS resource set for channel measurement, u is a scaling factor for multi-CSI report, n is number value.

O_{CPU}=u1*Ky+u*(n−u1), Ky is the number of active CSI-RS resources for channel measurement, u is a scaling factor for multi-CSI report, n is number value, u1 is another scaling factor.

In some embodiments, u1 is a predefined value.

In some embodiments, u1 is a value reported by UE (e.g., UE capability).

In some embodiments, u1 is a value indicated by RRC or MAC CE or DCI.

In some embodiments, the value indicated by RRC or MAC CE or DCI should not exceed the UE capability.

In some embodiments, u1 has different values for different numbers of CSI sets reported in one report.

In some embodiments, different UEs can report different u1 or u via UE capability. In some embodiments, u is a value greater than 0 and less than or equal to 1. u1 is a value greater than or equal to 0 and less than or equal to 8. For example, u1 can be 1, 2, or 0. u can be 1, 0.75, 0.5, 0.25, 0.3, 0.1, 0.2.

O_{CPU}=u1*Ks+u*(n−u1), Ks is the number of CSI-RS resources in the CSI-RS resource set for channel measurement, u is a scaling factor for multi-CSI report, n is number value, u1 is another scaling factor.

In some embodiments, n is a number value. For example, n is the number of CSI sets reported in one report, or n is the number of selected antenna patterns for channel measurement, or n is the number of CSI reports for one CSI report configuration.

In some embodiments, the number of active CSI-RS resources for channel measurement is the active CSI-RS resources for channel measurement when all the ports are used for CSI calculation.

In some embodiments, the number of active CSI-RS resources for channel measurement is 0 or 1 for CSI reports when part of the ports are used for CSI calculation.

In some embodiments, for multiple CSI report configurations associated with one CSI-RS resource, UE reports multiple CSI reports according to part of or all of the ports associated with the CSI-RS resource, for baseline CSI report configuration, the number of CPUs occupied by the CSI report configuration (O_{CPU}) is at least one of the following:

O_{CPU}=Ky, Ky is the number of active CSI-RS resources for channel measurement,

O_{CPU}=Kₛ, where Kₛ is the number of CSI-RS resources in the CSI-RS resource set for channel measurement.

In some embodiments, for multiple CSI report configurations associated with one CSI-RS resource, UE reports multiple CSI reports according to part of or all of the ports associated with the CSI-RS resource, for reference CSI report configuration, the number of CPUs occupied by the CSI report configuration (O_{CPU}) is at least one of the following:

O_{CPU}=Ky, Ky is the number of active CSI-RS resources for channel measurement.

O_{CPU}=Kₛ, where Kₛ is the number of CSI-RS resources in the CSI-RS resource set for channel measurement.

O_{CPU}=1.

O_{CPU}=0.

O_{CPU}=u.

O_{CPU}=u*Ky, Ky is the number of active CSI-RS resources for channel measurement.

O_{CPU}=u*Ks, where Kₛ is the number of CSI-RS resources in the CSI-RS resource set for channel measurement.

In some embodiments, u is a predefined value.

In some embodiments, u is a value reported by UE (e.g., UE capability).

In some embodiments, u is a value indicated by RRC or MAC CE or DCI.

In some embodiments, the value indicated by RRC or MAC CE or DCI should not exceed the UE capability.

In some embodiments, u has different values for different numbers of CSI sets reported in one report.

In some embodiments, for CSI report configurations configured with multiple CSI reports, for a baseline CSI report, the number of CPUs occupied by the CSI report (O_{CPU}) is at least one of the following:

O_{CPU}=Ky, Ky is the number of active CSI-RS resources for channel measurement of the CSI report,

O_{CPU}=Kₛ, where Kₛ is the number of CSI-RS resources in the CSI-RS resource set for channel measurement of the CSI report.

In some embodiments, for CSI report configurations configured with multiple CSI reports, for a reference CSI report, the number of CPUs occupied by the CSI report (O_{CPU}) is at least one of the following:

O_{CPU}=Ky, Ky is the number of active CSI-RS resources for channel measurement of the CSI report.

O_{CPU}=Kₛ, where Kₛ is the number of CSI-RS resources in the CSI-RS resource set for channel measurement of the CSI report.

O_{CPU}=1.

O_{CPU}=0.

O_{CPU}=u.

O_{CPU}=u*Ky, Ky is the number of active CSI-RS resources for channel measurement of the CSI report.

O_{CPU}=u*Ks, where Kₛ is the number of CSI-RS resources in the CSI-RS resource set for channel measurement of the CSI report.

In some embodiments, u is a predefined value.

In some embodiments, u is a value reported by UE (e.g., UE capability).

In some embodiments, u is a value indicated by RRC or MAC CE or DCI.

In some embodiments, the value indicated by RRC or MAC CE or DCI should not exceed the UE capability.

In some embodiments, u has different values for different numbers of CSI sets reported in one report.

In some embodiments, for a CSI report configuration associated with one CSI-RS resource, and UE uses different power offset values associated with the CSI-RS resource for CSI report calculation and reports multiple CSI sets in one report or report multiple CSI reports, or for a CSI report configuration associated with a CSI-RS resource configured with multiple power offsets, UE reports multiple CSI reports or report multiple CSI sets in one reporting according to multiple of the power offsets, the number of CPUs occupied by the CSI report configuration (O_{CPU}) is at least one of the following:

O_{CPU}=1.

O_{CPU}=Ky, Ky is the number of active CSI-RS resources for channel measurement.

O_{CPU}=Kₛ, where Kₛ is the number of CSI-RS resources in the CSI-RS resource set for channel measurement.

In some embodiments, when L=0, CPUs are occupied, and for the CSI report that includes multiple sets of CSIs, O_{CPU}=N_{CPU}.

In some embodiments, when L=0, CPUs are occupied, and for the CSI report that includes multiple sets of CSIs, O_{CPU}=N_{CPU}−L.

In some embodiments, when L=0, CPUs are occupied, and for all CSI reports that are configured in one CSI report configuration, O_{CPU}=N_{CPU}.

In some embodiments, when L=0, CPUs are occupied, and for all CSI reports that are configured in one CSI report configuration, O_{CPU}=N_{CPU}−L.

In some embodiments, the number of CSI sets reported in one report can be changed. In other words, the number of CSI sets reported in one report according to a CSI report configuration can be changed. For example, a DCL or a MAC CE indicates an active CSI-RS resource change. The number of CSI sets reported in one report is also changed. For another example, a DCI or a MAC CE indicates the number of CSI sets reported in one report changes. For another example, a DCI or a MAC CE indicates port indexes which are used to process a CSI report change. The number of CSI sets reported in one report is also changed. To summarize, a DCI or a MAC CE may indicate a change associated with a first CSI report configuration. The change may lead the number of CSI sets reported in one report to change.

If the number of CSI sets reported in one report according to a CSI report configuration changes, the number of CPUs occupied by the CSI report configuration (O_{CPU}) may also change. Therefore, in different times, the number of CPUs occupied by a CSI report configuration may be different.

For a CSI report with CSI-ReportConfig with higher layer parameter reportQuantity not set to ‘none,’ the CPU(s) occupied for a number of OFDM symbols follows at least one of the following:

A periodic or semi-persistent CSI report (excluding an initial semi-persistent CSI report on PUSCH after the PDCCH triggering the report, and excluding a first CSI report after a first signaling triggering the CSI report change or excluding a last CSI report before a first signaling triggering the CSI report change) occupies CPU(s) from the first symbol of the earliest one of each CSI-RS/CSI-IM/SSB resource for channel or interference measurement, respective latest CSI-RS/CSI-IM/SSB occasion no later than the corresponding CSI reference resource, until the last symbol of the configured PUSCH/PUCCH carrying the report.

A first CSI report after a first signaling triggering the CSI report change occupies CPU(s) from a first position until a second position.

The first position is at least one of the following:

The first symbol after the first signaling.

First signaling is a DCI or a MAC CE.

The first symbol of the first valid/or active one of each CSI-RS/CSI-IM/SSB resource for channel or interference measurement, respective latest CSI-RS/CSI-IM/SSB occasion no later than the corresponding CSI reference resource.

The first symbol of the first valid/active one of each CSI-RS/CSI-IM/SSB resource for channel or interference measurement that is after N symbols/slots after the first signaling.

The first symbol of the earliest one of each CSI-RS/CSI-IM/SSB resource for channel or interference measurement.

N symbol/slot after the first signaling.

N is a predefined value.

N is configured by RRC signaling.

N is reported by UE capability.

N is a same or different values for different sub carrier spacings (SCSs).

The first or last symbol of an ACK associated with the first signaling.

The first symbol or slot after an ACK associated with the first signaling.

The first or last symbol after N symbols/slots after an ACK associated with the first signaling.

The first or last slot after N symbols/slots after an ACK associated with the first signaling, or

The first symbol of the first one of each CSI-RS/CSI-IM/SSB resource for channel or interference measurement in next CSI-RS/CSI-IM/SSB cycle, respective latest CSI-RS/CSI-IM/SSB occasion no later than the corresponding CSI reference resource.

The second position includes at least one of the following:

The last symbol of the scheduled PUSCH carrying the report.

The last symbol of the configured PUSCH or PUCCH carrying the report, or

The first symbol of a first signaling which trigger a CSI report change.

A last CSI report before a first signaling triggering the CSI report change occupies CPU(s) from a third position until a fourth position.

The third position is at least one of the following:

The first symbol of the earliest one of each CSI-RS/CSI-IM/SSB resource for channel or interference measurement, respective latest CSI-RS/CSI-IM/SSB occasion no later than the corresponding CSI reference resource.

The first symbol of the earliest one of each valid/selected/activated CSI-RS/CSI-IM/SSB resource for channel or interference measurement, respective latest CSI-RS/CSI-IM/SSB occasion no later than the corresponding CSI reference resource.

The first symbol of the earliest one of each CSI-RS/CSI-IM/SSB resource for channel or interference measurement.

The first symbol of the earliest valid/selected/activated one of each CSI-RS/CSI-IM/SSB resource for channel or interference measurement.

The first symbol after a first signaling triggering the CSI report, or triggering the CSI report change.

The fourth position includes at least one of the following:

The latest CSI-RS/CSI-IM/SSB occasion no later than the first signaling.

The latest valid/selected/activated CSI-RS/CSI-IM/SSB occasion no later than the first signaling.

The first or last symbol of the first signaling.

The first symbol or slot after the first signaling.

The first or last symbol of an ACK associated with the first signaling.

The first symbol or slot after an ACK associated with the first signaling.

A first CSI report after a first signaling triggering the CSI report change occupies CPU(s) from the first symbol after the first signaling until the last symbol of the scheduled PUSCH carrying the report.

A first CSI report after a first signaling triggering the CSI report change occupies CPU(s) from the first symbol after the first signaling until the last symbol of the configured PUSCH or PUCCH carrying the report.

A first CSI report after a first signaling triggering the CSI report change occupies CPU(s) from the first symbol of the first valid or active one of each CSI-RS/CSI-IM/SSB resource for channel or interference measurement, respective latest CSI-RS/CSI-IM/SSB occasion no later than the corresponding CSI reference resource, until the last symbol of the configured PUSCH or PUCCH carrying the report.

A first CSI report after a first signaling triggering the CSI report change occupies CPU(s) from the first symbol after a PDCCH until the last symbol of the configured PUSCH or PUCCH carrying the report. When the PDCCH reception includes two PDCCH candidates from two respective search space sets, for the purpose of determining the CPU occupation duration, the PDCCH candidate that ends later in time is used.

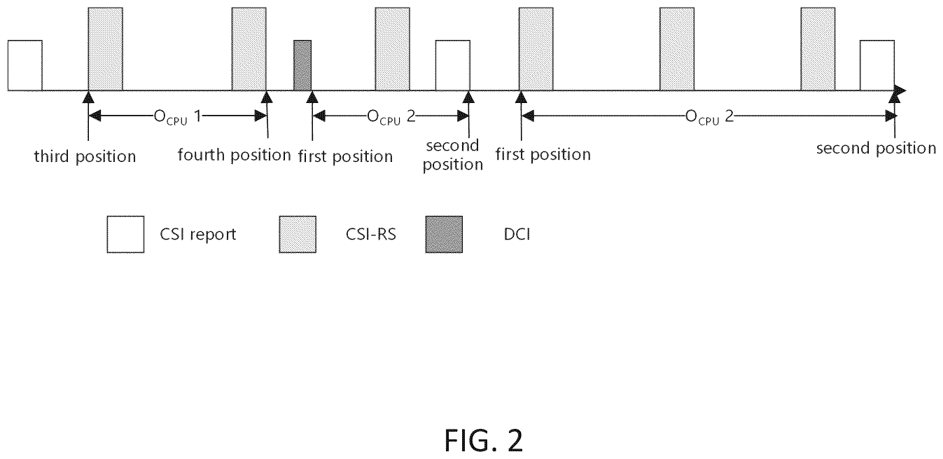

Example: As shown in FIG. 2, a DCI changes the number of CSI sets reported in one report of a CSI report configuration. In different times, the occupied CPUs of the CSI report configuration are different.

For the last CSI report before the DCI, the CSI report configuration occupies CPU (O_{CPU}1) from the first symbol of the first valid or active one of each CSI-RS/CSI-IM/SSB resource for channel or interference measurement, until the latest CSI-RS/CSI-IM/SSB occasion no later than the first signaling.

For the first CSI report after the DCI, the CSI report configuration occupies CPU (O_{CPU}2) from the first symbol after the DCI, until the last symbol of the PUCCH or PUSCH carrying the report.

For the periodic CSI report (excluding an initial semi-persistent CSI report on PUSCH after the PDCCH triggering the report, and excluding a first CSI report after a first signaling triggering the CSI report change or excluding a last CSI report before a first signaling triggering the CSI report change) occupies CPU (O_{CPU}2) from the first symbol of the earliest one of each valid/selected/activated CSI-RS/CSI-IM/SSB resource for channel or interference measurement, respective latest valid/selected/activated CSI-RS/CSI-IM/SSB occasion no later than the corresponding CSI reference resource, until the last symbol of the configured PUSCH/PUCCH carrying the report.

In any slot, the UE is not expected to have more active CSI-RS ports or active CSI-RS resources in active bandwidth parts (BWPs) than reported as capability. If a first signaling indicates a CSI report change or indicates an active CSI-RS port or active CSI-RS resource of the CSI report change, the active CSI-RS ports or active CSI-RS resources of the CSI report configuration will change.

NZP CSI-RS resource is active in a duration of time defined as follows.

For semi-persistent CSI-RS, starting from the end of when the activation command is applied or the first symbol after a first signaling which trigger an active port or active CSI-RS resource change, and ending at the end of when the deactivation command is applied or ending at the end of when receiving a first signaling which trigger an active port or active CSI-RS resource change.

In some embodiments, for a semi-persistent CSI-RS, starting from the first valid/selected/activated CSI-RS occasion after a first signaling that triggers an active port or active CSI-RS resource change, and ending at the end of when the deactivation command is applied or ending at the end of when receiving a first signaling that triggers an active port or active CSI-RS resource change.

For periodic CSI-RS, starting when the periodic CSI-RS is configured by higher layer signaling or the first symbol after a first signaling which trigger an active port or active CSI-RS resource change, and ending when the periodic CSI-RS configuration is released or ending at the end of when receiving a first signaling which trigger an active port or active CSI-RS resource change.

In some embodiments, for a periodic CSI-RS, starting when the periodic CSI-RS is configured by a higher layer signaling or the first valid/selected/activated CSI-RS occasion after a first signaling that triggers an active port or active CSI-RS resource change, and ending when the periodic CSI-RS configuration is released or ending at the end of when receiving a first signaling that triggers an active port or active CSI-RS resource change.

If a CSI-RS resource is referred N times by one or more CSI Report configuration, the CSI-RS resources within the CSI-RS resource are counted N times. If all or part of the ports in one CSI-RS resource are used for multiple CSI sets in one or multiple CSI reports, the active ports have the same value by adding the active ports in each CSI report together.

In some embodiments, if a CSI-RS resource is referred N times by one or more CSI reports, the CSI-RS resources within the CSI-RS resource set are counted N times.

In some embodiments, if a CSI-RS resource is referred N times for one or more CSI sets, the CSI-RS resources within the CSI-RS resource set are counted N times.

In some embodiments, if a CSI-RS resource is referred N times by one or more CSI reports, the CSI-RS resources within the CSI-RS resource set are counted only one time.

In some embodiments, if a CSI-RS resource is referred N times for one or more CSI sets, the CSI-RS resources within the CSI-RS resource set are counted only one time.

In some embodiments, if a CSI-RS resource is referred N times by one or more CSI reports, the CSI-RS resources within the CSI-RS resource set are counted N*μ times.

In some embodiments, if a CSI-RS resource is referred N times for one or more CSI sets, the CSI-RS resources within the CSI-RS resource set are counted N*μ times. μ is a scaling factor.

For periodic or semi-persistent CSI-RS which receives a first signaling which trigger an active port or active CSI-RS resource change, the indicated ports or CSI-RS resource are activated after a fifth position. The fifth position is at least one of the following:

The first symbol of the earliest one of each CSI-RS/CSI-IM/SSB resource for channel or interference measurement in next CSI-RS or CSI-IM or SSB resource cycle or the earliest one of each CSI-RS/CSI-IM/SSB resource for channel or interference measurement in next CSI report cycle.

The first symbol of the earliest one of each CSI-RS/CSI-IM/SSB resource for channel or interference measurement after the first signaling.

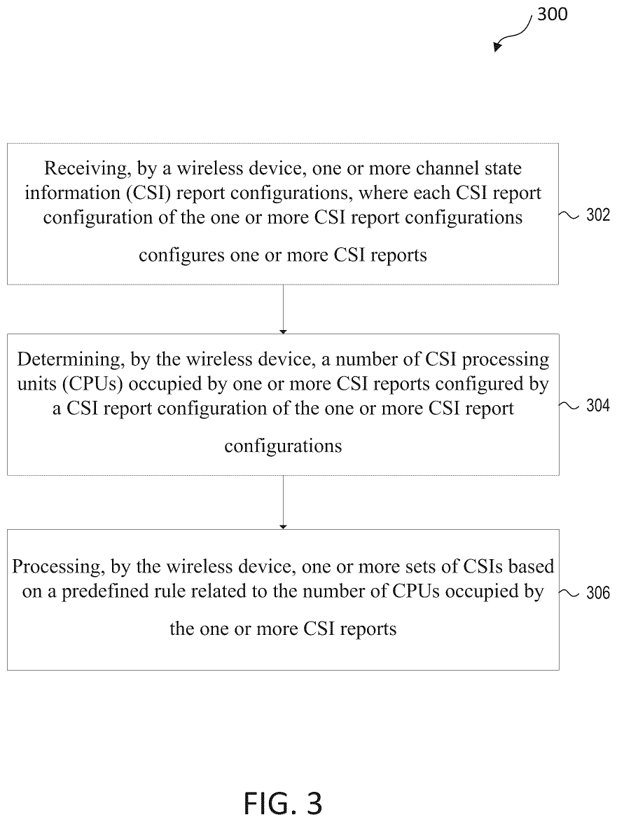

FIG. 3 is an exemplary flowchart for processing CSIs. Operation 302 includes receiving, by a wireless device, one or more channel state information (CSI) report configurations, where each CSI report configuration of the one or more CSI report configurations configures one or more CSI reports. Operation 304 includes determining, by the wireless device, a number of CSI processing units (CPUs) occupied by one or more CSI reports configured by a CSI report configuration of the one or more CSI report configurations. Operation 306 includes processing, by the wireless device, one or more sets of CSIs based on a predefined rule related to the number of CPUs occupied by the one or more CSI reports. In some embodiments, the method can be implemented according to Embodiments 1-9. In some embodiments, performing further steps of the method can be based on a better system performance than a legacy protocol.

In some embodiments, the one or more CSI reports include at least one of the following: a single CSI report including a single set of CSIs (single-CSI), a single CSI report including multiple sets of CSIs (multi-CSI), and multiple CSI reports with each CSI report including a single set of CSIs (multi-reporting).

In some embodiments, processing the one or more sets of CSIs based on the predefined rule includes determining a first priority of a multi-CSI report configured by a first CSI report configuration of the one or more CSI report configurations and determining a second priority of a single-CSI report configured by a second CSI report configuration of the one or more CSI report configurations, where the first priority is higher than the second priority.

In some embodiments, processing the one or more sets of CSIs based on the predefined rule includes determining a first priority of a first CSI report configured by a first CSI report configuration of the one or more CSI report configurations, where a first number of CPUs occupied by the first CSI report is less than or equal to a total number of CPUs. Processing the one or more sets of CSIs based on the predefined rule further includes determining a second priority of a second CSI report configured by a second CSI report configuration of the one or more CSI report configurations, where a second number of CPUs occupied by the second CSI report is greater than the total number of CPUs, and where the first priority is higher than the second priority.

In some embodiments, processing the one or more sets of CSIs based on the predefined rule includes determining a first priority of a first CSI report, where the first CSI report is a baseline CSI report. Processing the one or more sets of CSIs based on the predefined rule further includes determining a second priority of a second CSI report, where the second CSI report is a reference CSI report, and where the first priority is higher than the second priority.

In some embodiments, the number of CPUs occupied by the one or more CSI reports configured by the CSI report configuration is a number of active CSI reference signal (CSI-RS) resources for channel measurement if the wireless device uses all ports associated with the active CSI-RS resources for CSI report calculation.

In some embodiments, the number of CPUs occupied by the one or more CSI reports configured by the CSI report configuration is 0 or 1 if the wireless device uses part of all ports associated with active CSI reference signal (CSI-RS) resources for CSI report calculation.

In some embodiments, the CSI report configuration configures a multi-CSI report or a multi-reporting, and the number of CPUs occupied by the multi-CSI report or the multi-reporting is based on at least one of the following: a number of active CSI reference signal (CSI-RS) resources for channel measurement, a number of selected antenna patterns for channel measurement, a number of CSI sets in the multi-CSI report, a number of CSI reports in the multi-reporting, a number of physical uplink control channel (PUCCH) resource parameter sets, a number of CSI-RS resources in a CSI-RS resource set for channel measurement, a number of CSI-RS resources in an antenna pattern for channel measurement, and a scaling factor. In some embodiments, the scaling factor is at least one of the following: a scaling factor for the multi-CSI report, a scaling factor for the multi-reporting, a predefined value, a value reported by the wireless device, and a value indicated by a higher layer parameter. In some embodiments, the scaling factor for the multi-CSI report varies according to the number of CSI sets in the multi-CSI report.

In some embodiments, the CSI report configuration configures a multi-CSI report, where the number of CPUs occupied by the multi-CSI report is determined by Ky+u*Ky*(n−1), where Ky is a number of active CSI reference signal (CSI-RS) resources for channel measurement, where u is a scaling factor for the multi-CSI report, and where n is a number of CSI sets in the multi-CSI report.

In some embodiments, the CSI report configuration configures a CSI report based on a reference type of CSI report configurations, and the number of CPUs occupied by the CSI report is based on at least one of the following: a number of active CSI reference signal (CSI-RS) resources for channel measurement, a number of CSI-RS resources in a CSI-RS resource set for channel measurement, 0, 1, and a scaling factor. In some embodiments, the scaling factor is at least one of the following: a predefined value, a value reported by the wireless device, and a value indicated by a higher layer parameter.

In some embodiments, the CSI report configuration configures a multi-CSI report according to multiple power offsets, and the number of CPUs occupied by the multi-CSI report is based on at least one of the following: a number of active CSI reference signal (CSI-RS) resources for channel measurement, a number of CSI-RS resources for channel measurement for one set of CSIs, a number of CSI-RS resources in a CSI-RS resource set for channel measurement, and 1.

In some embodiments, the CSI report configuration configures a periodic or semi-persistent CSI report, where the periodic or semi-persistent CSI report excludes an initial semi-persistent CSI report on a physical uplink shared channel (PUSCH) after a physical downlink control channel (PDCCH) triggers the periodic or semi-persistent CSI report, where the periodic or semi-persistent CSI report excludes a first CSI report after a first signaling triggers a CSI report change, where the periodic or semi-persistent CSI report excludes a last CSI report before the first signaling triggers the CSI report change, and where the periodic or semi-persistent CSI report occupies one or more CPUs from a first symbol of an earliest CSI reference signal (CSI-RS), CSI interference measurement (CSI-IM), or synchronization signal block (SSB) resource for channel or interference measurement, to a latest CSI-RS, CSI-IM, or SSB occasion no later than a corresponding CSI reference resource, and to a last symbol of a configured PUSCH or physical uplink control channel (PUCCH) carrying the periodic or semi-persistent CSI report.

In some embodiments, the first CSI report after the first signaling triggers the CSI report change occupies one or more CPUs from a first position to a second position. In some embodiments, the first position is at least one of the following: a first symbol after the first signaling, a predetermined symbol after the first signaling, a predetermined slot after the first signaling, a first symbol after an ACK associated with the first signaling, a first symbol of a first active CSI-RS/CSI-IM/SSB resource for channel or interference measurement, a first symbol of a first active CSI-RS/CSI-IM/SSB resource for channel or interference measurement after the first signaling, and the first symbol of the earliest CSI-RS/CSI-IM/SSB resource for channel or interference measurement. In some embodiments, the predetermined symbol is based on at least one of the following: a predefined value, a value configured by the first signaling, and a value reported by the wireless device. In some embodiments, the second position is at least one of the following: a last symbol of a scheduled PUSCH carrying the first CSI report, a last symbol of a configured PUSCH or PUCCH carrying the first CSI report, and a first symbol after the first signaling.

In some embodiments, the last CSI report before the first signaling triggers the CSI report change occupies one or more CPUs from a third position to a fourth position.

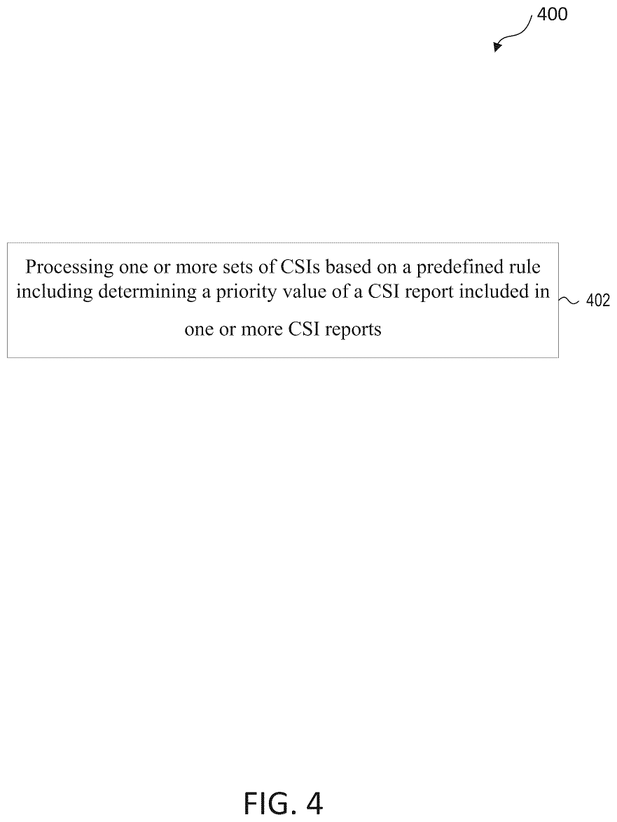

FIG. 4 is an exemplary flowchart for determining a priority value of a CSI report. Operation 402 includes processing one or more sets of CSIs based on a predefined rule including determining a priority value of a CSI report included in one or more CSI reports. In some embodiments, the method can be implemented according to Embodiments 1-9. In some embodiments, performing further steps of the method can be based on a better system performance than a legacy protocol.

In some embodiments, the priority value of the CSI report is determined based on at least one of the following: a time domain behavior type of the CSI report configuration, a CSI-related report quantity type, a serving cell index, a maximum number of serving cells, a report configuration identification (ID), a maximum number of CSI report configurations, a CSI report type indicator, a multi-CSI indication, a multi-reporting indication, a number of physical uplink control channel (PUCCH) resource parameter sets, a scaling factor, and a number of CSI sets indication.

In some embodiments, the CSI report type indicator is a value about whether the CSI report is based on a baseline type of CSI report configurations or a reference type of CSI report configurations. In some embodiments, the CSI report type indicator is 1 if the CSI report is based on a reference type of CSI report configurations, and the CSI report type indicator is 0 if the CSI report is based on a baseline type of CSI report configurations.

In some embodiments, the multi-CSI indication is a value about whether the CSI report includes multiple sets of CSIs. In some embodiments, the multi-CSI indication is 0 if the CSI report includes multiple sets of CSIs, and the multi-CSI indication is 1 if the CSI report does not include multiple sets of CSIs.

In some embodiments, the number of CSI sets indication is a value about whether more than one set of CSIs is reported in the CSI report. In some embodiments, the number of CSI sets indication is 0 if more than one set of CSIs is reported in the CSI report, and the number of CSI sets indication is 1 if not more than one set of CSIs is reported in the CSI report. In some embodiments, the number of CSI sets indication is a value about a number of CSI sets reported in the CSI report.

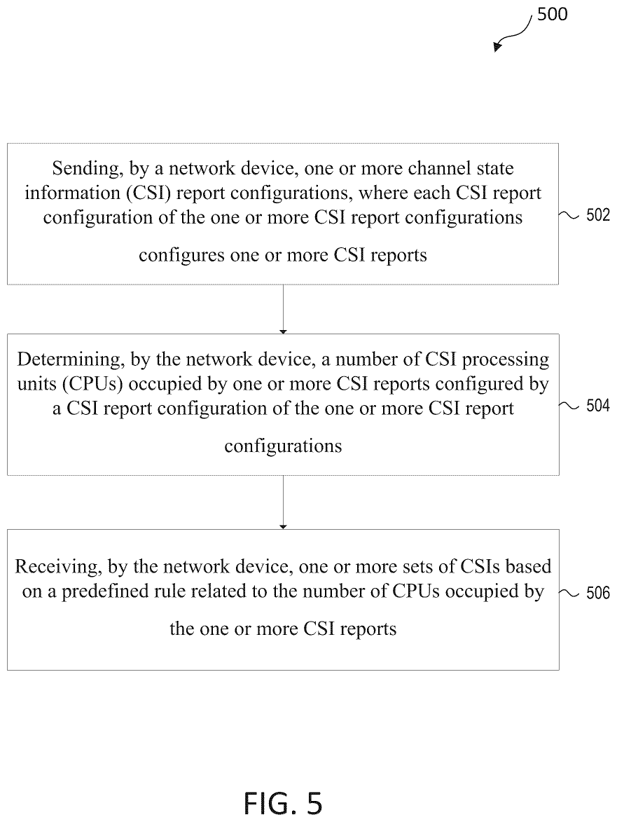

FIG. 5 is an exemplary flowchart for receiving CSIs. Operation 502 includes sending, by a network device, one or more channel state information (CSI) report configurations, where each CSI report configuration of the one or more CSI report configurations configures one or more CSI reports. Operation 504 includes determining, by the network device, a number of CSI processing units (CPUs) occupied by one or more CSI reports configured by a CSI report configuration of the one or more CSI report configurations. Operation 506 includes receiving, by the network device, one or more sets of CSIs based on a predefined rule related to the number of CPUs occupied by the one or more CSI reports. In some embodiments, the method can be implemented according to Embodiments 1-9. In some embodiments, performing further steps of the method can be based on a better system performance than a legacy protocol.

In some embodiments, the one or more CSI reports include at least one of the following: a single CSI report including a single set of CSIs (single-CSI), a single CSI report including multiple sets of CSIs (multi-CSI), and multiple CSI reports with each CSI report including a single set of CSIs (multi-reporting).

In some embodiments, receiving the one or more sets of CSIs based on the predefined rule includes determining a first priority of a multi-CSI report configured by a first CSI report configuration of the one or more CSI report configurations and determining a second priority of a single-CSI report configured by a second CSI report configuration of the one or more CSI report configurations, where the first priority is higher than the second priority.

In some embodiments, receiving the one or more sets of CSIs based on the predefined rule includes determining a first priority of a first CSI report configured by a first CSI report configuration of the one or more CSI report configurations, where a first number of CPUs occupied by the first CSI report is less than or equal to a total number of CPUs. Receiving the one or more sets of CSIs based on the predefined rule further includes determining a second priority of a second CSI report configured by a second CSI report configuration of the one or more CSI report configurations, where a second number of CPUs occupied by the second CSI report is greater than the total number of CPUs, and where the first priority is higher than the second priority.

In some embodiments, receiving the one or more sets of CSIs based on the predefined rule includes determining a first priority of a first CSI report, where the first CSI report is a baseline CSI report. Receiving the one or more sets of CSIs based on the predefined rule further includes determining a second priority of a second CSI report, where the second CSI report is a reference CSI report, and where the first priority is higher than the second priority.

In some embodiments, the number of CPUs occupied by the one or more CSI reports configured by the CSI report configuration is a number of active CSI reference signal (CSI-RS) resources for channel measurement if a wireless device uses all ports associated with the active CSI-RS resources for CSI report calculation.

In some embodiments, the number of CPUs occupied by the one or more CSI reports configured by the CSI report configuration is 0 or 1 if a wireless device uses part of all ports associated with active CSI reference signal (CSI-RS) resources for CSI report calculation.

In some embodiments, the CSI report configuration configures a multi-CSI report or a multi-reporting, and the number of CPUs occupied by the multi-CSI report or the multi-reporting is based on at least one of the following: a number of active CSI reference signal (CSI-RS) resources for channel measurement, a number of selected antenna patterns for channel measurement, a number of CSI sets in the multi-CSI report, a number of CSI reports in the multi-reporting, a number of physical uplink control channel (PUCCH) resource parameter sets, a number of CSI-RS resources in a CSI-RS resource set for channel measurement, a number of CSI-RS resources in an antenna pattern for channel measurement, and a scaling factor. In some embodiments, the scaling factor is at least one of the following: a scaling factor for the multi-CSI report, a scaling factor for the multi-reporting, a predefined value, a value reported by a wireless device, and a value indicated by a higher layer parameter. In some embodiments, the scaling factor for the multi-CSI report varies according to the number of CSI sets in the multi-CSI report.

In some embodiments, the CSI report configuration configures a multi-CSI report, where the number of CPUs occupied by the multi-CSI report is determined by Ky+u*Ky*(n−1), where Ky is a number of active CSI reference signal (CSI-RS) resources for channel measurement, where u is a scaling factor for the multi-CSI report, and where n is a number of CSI sets in the multi-CSI report.

In some embodiments, the CSI report configuration configures a CSI report based on a reference type of CSI report configurations, and the number of CPUs occupied by the CSI report is based on at least one of the following: a number of active CSI reference signal (CSI-RS) resources for channel measurement, a number of CSI-RS resources in a CSI-RS resource set for channel measurement, 0, 1, and a scaling factor. In some embodiments, the scaling factor is at least one of the following: a predefined value, a value reported by a wireless device, and a value indicated by a higher layer parameter.

In some embodiments, the CSI report configuration configures a multi-CSI report according to multiple power offsets, and the number of CPUs occupied by the multi-CSI report is based on at least one of the following: a number of active CSI reference signal (CSI-RS) resources for channel measurement, a number of CSI-RS resources for channel measurement for one set of CSIs, a number of CSI-RS resources in a CSI-RS resource set for channel measurement, and 1.

In some embodiments, the CSI report configuration configures a periodic or semi-persistent CSI report, where the periodic or semi-persistent CSI report excludes an initial semi-persistent CSI report on a physical uplink shared channel (PUSCH) after a physical downlink control channel (PDCCH) triggers the periodic or semi-persistent CSI report, where the periodic or semi-persistent CSI report excludes a first CSI report after a first signaling triggers a CSI report change, where the periodic or semi-persistent CSI report excludes a last CSI report before the first signaling triggers the CSI report change, and where the periodic or semi-persistent CSI report occupies one or more CPUs from a first symbol of an earliest CSI reference signal (CSI-RS), CSI interference measurement (CSI-IM), or synchronization signal block (SSB) resource for channel or interference measurement, to a latest CSI-RS, CSI-IM, or SSB occasion no later than a corresponding CSI reference resource, and to a last symbol of a configured PUSCH or physical uplink control channel (PUCCH) carrying the periodic or semi-persistent CSI report.

In some embodiments, the first CSI report after the first signaling triggers the CSI report change occupies one or more CPUs from a first position to a second position. In some embodiments, the first position is at least one of the following: a first symbol after the first signaling, a predetermined symbol after the first signaling, a predetermined slot after the first signaling, a first symbol after an ACK associated with the first signaling, a first symbol of a first active CSI-RS/CSI-IM/SSB resource for channel or interference measurement, a first symbol of a first active CSI-RS/CSI-IM/SSB resource for channel or interference measurement after the first signaling, and the first symbol of the earliest CSI-RS/CSI-IM/SSB resource for channel or interference measurement. In some embodiments, the predetermined symbol is based on at least one of the following: a predefined value, a value configured by the first signaling, and a value reported by the wireless device. In some embodiments, the second position is at least one of the following: a last symbol of a scheduled PUSCH carrying the first CSI report, a last symbol of a configured PUSCH or PUCCH carrying the first CSI report, and a first symbol after the first signaling.

In some embodiments, the last CSI report before the first signaling triggers the CSI report change occupies one or more CPUs from a third position to a fourth position.

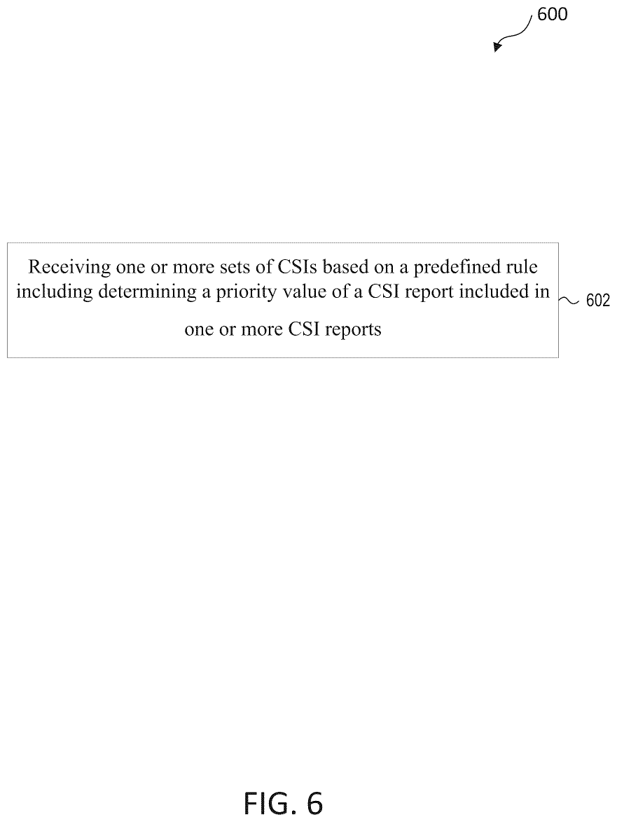

FIG. 6 is an exemplary flowchart for receiving CSIs based on a priority value of a CSI report. Operation 602 includes receiving one or more sets of CSIs based on a predefined rule including determining a priority value of a CSI report included in one or more CSI reports. In some embodiments, the method can be implemented according to Embodiments 1-9. In some embodiments, performing further steps of the method can be based on a better system performance than a legacy protocol.

In some embodiments, the priority value of the CSI report is determined based on at least one of the following: a time domain behavior type of the CSI report configuration, a CSI-related report quantity type, a serving cell index, a maximum number of serving cells, a report configuration identification (ID), a maximum number of CSI report configurations, a CSI report type indicator, a multi-CSI indication, a multi-reporting indication, a number of physical uplink control channel (PUCCH) resource parameter sets, a scaling factor, and a number of CSI sets indication.

In some embodiments, the CSI report type indicator is a value about whether the CSI report is based on a baseline type of CSI report configurations or a reference type of CSI report configurations. In some embodiments, the CSI report type indicator is 1 if the CSI report is based on a reference type of CSI report configurations, and the CSI report type indicator is 0 if the CSI report is based on a baseline type of CSI report configurations.

In some embodiments, the multi-CSI indication is a value about whether the CSI report includes multiple sets of CSIs. In some embodiments, the multi-CSI indication is 0 if the CSI report includes multiple sets of CSIs, and the multi-CSI indication is 1 if the CSI report does not include multiple sets of CSIs.

In some embodiments, the number of CSI sets indication is a value about whether more than one set of CSIs is reported in the CSI report. In some embodiments, the number of CSI sets indication is 0 if more than one set of CSIs is reported in the CSI report, and the number of CSI sets indication is 1 if not more than one set of CSIs is reported in the CSI report. In some embodiments, the number of CSI sets indication is a value about a number of CSI sets reported in the CSI report.

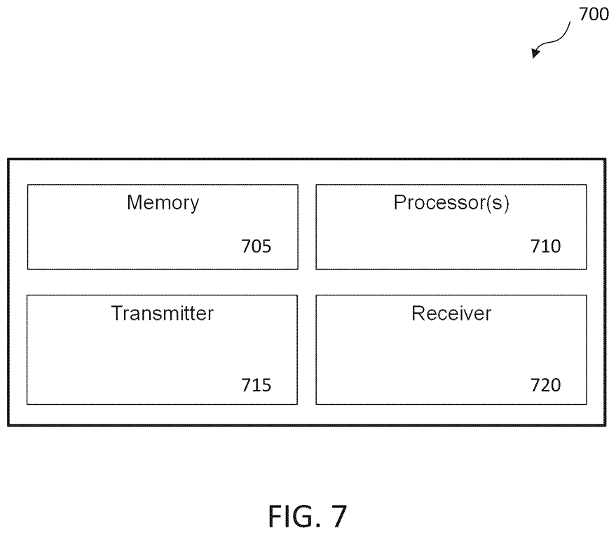

FIG. 7 shows an exemplary block diagram of a hardware platform 700 that may be a part of a network device (e.g., base station) or a communication device (e.g., a user equipment (UE)). The hardware platform 700 includes at least one processor 710 and a memory 705 having instructions stored thereupon. The instructions upon execution by the processor 710 configure the hardware platform 700 to perform the operations described in FIGS. 1 to 6 and in the various embodiments described in this patent document. The transmitter 715 transmits or sends information or data to another device. For example, a network device transmitter can send a message to a user equipment. The receiver 720 receives information or data transmitted or sent by another device. For example, a user equipment can receive a message from a network device. For example, a UE or a network device, as described in the present document, may be implemented using the hardware platform 700.

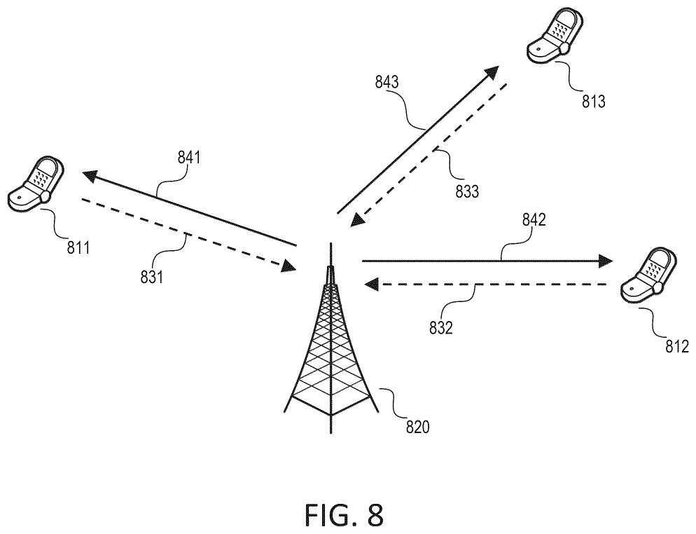

The implementations as discussed above will apply to a wireless communication. FIG. 8 shows an example of a wireless communication system (e.g., a 5G or NR cellular network) that includes a base station 820 and one or more user equipment (UE) 811, 812 and 813. In some embodiments, the UEs access the BS (e.g., the network) using a communication link to the network (sometimes called uplink direction, as depicted by dashed arrows 831, 832, 833), which then enables subsequent communication (e.g., shown in the direction from the network to the UEs, sometimes called downlink direction, shown by arrows 841, 842, 843) from the BS to the UEs. In some embodiments, the BS send information to the UEs (sometimes called downlink direction, as depicted by arrows 841, 842, 843), which then enables subsequent communication (e.g., shown in the direction from the UEs to the BS, sometimes called uplink direction, shown by dashed arrows 831, 832, 833) from the UEs to the BS. The UE may be, for example, a smartphone, a tablet, a mobile computer, a machine to machine (M2M) device, an Internet of Things (IoT) device, and so on. The UEs described in the present document may be communicatively coupled to the base station 820 depicted in FIG. 8. The UEs can also communicate with BS for CSI communications.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A method of wireless communication, comprising:
receiving, by a wireless device, one or more channel state information (CSI) report configurations, wherein each CSI report configuration of the one or more CSI report configurations configures one or more CSI reports;
determining, by the wireless device, a number of CSI processing units (CPUs) occupied by one or more CSI reports configured by a CSI report configuration of the one or more CSI report configurations; and
processing, by the wireless device, one or more sets of CSIs based on the number of CPUs occupied by the one or more CSI reports.

2. The method of claim 1, wherein the one or more CSI reports comprise at least one of the following: a single CSI report comprising a single set of CSIs (single-CSI), a single CSI report comprising multiple sets of CSIs (multi-CSI), or multiple CSI reports with each CSI report comprising a single set of CSIs (multi-reporting).

3. The method of claim 1, wherein the CSI report configuration configures a multi-CSI report or a multi-reporting, and wherein the number of CPUs occupied by the multi-CSI report or the multi-reporting is based on at least one of the following: a number of CSI sets in the multi-CSI report, a number of CSI reports in the multi-reporting, or a number of CSI-RS resources in a CSI-RS resource set for channel measurement.

4. The method of claim 1, wherein the CSI report configuration is associated with a CSI reference signal (CSI-RS) resource, and
wherein the processing the one or more sets of CSIs comprises the wireless device using a part of or all ports associated with the CSI-RS resource for CSI report calculation and reporting multiple sets of CSIs.

5. The method of claim 4, wherein the reporting the multiple sets of CSIs comprises the wireless device reporting a single CSI report with the multiple sets of CSIs.

6. The method of claim 4, wherein when the part of or all ports associated with the CSI-RS resource is used for multiple sets of CSIs in the one or more CSI reports, a number of active ports is determined by adding active ports in each of the one or more CSI reports together.

7. The method of claim 4, wherein when the CSI-RS resource is referred N times for one or more sets of CSIs, the CSI-RS resource is counted N times.

8. The method of claim 4, wherein the number of CPUs occupied by the one or more CSI reports is equal to Kₛ*n, wherein Kₛ is a number of CSI-RS resources in a CSI-RS resource set for channel measurement, and wherein n is a number of sets of CSIs reported.

9. The method of claim 1, wherein the CSI report configuration is associated with a CSI reference signal (CSI-RS) resource configured with multiple antenna patterns, wherein the one or more CSI reports comprises a single CSI report comprising multiple sets of CSIs according to the multiple antenna patterns for reporting by the wireless device, and wherein an antenna pattern of the multiple antenna patterns includes at least one of the following: a port index indication, a group indication or a power offset.

10. The method of claim 9, wherein the reporting the multiple sets of CSIs comprises the wireless device reporting a single CSI report with the multiple sets of CSIs.

11. The method of claim 9, wherein when a part of or all ports associated with the CSI-RS resource is used for multiple sets of CSIs in the one or more CSI reports, a number of active ports is determined by adding active ports in each of the one or more CSI reports together.

12. The method of claim 9, wherein when the CSI-RS resource is referred N times for one or more sets of CSIs, the CSI-RS resource is counted N times.

13. The method of claim 9, wherein the number of CPUs occupied by the one or more CSI reports is equal to Kₛ*n, wherein Kₛ is a number of CSI-RS resources in a CSI-RS resource set for channel measurement, and wherein n is a number of sets of CSIs reported.

14. The method of claim 1, wherein the one or more CSI reports comprises a single CSI report comprising multiple sets of CSIs for reporting by the wireless device,
wherein the number of CPUs occupied by the one or more CSI reports is equal to Kₛ*n, wherein Kₛ is a number of CSI reference signal (CSI-RS) resources in a CSI-RS resource set for channel measurement, and wherein n is a number of sets of CSIs reported in the single CSI report.

15. A method of wireless communication, comprising:
sending, by a network device, one or more channel state information (CSI) report configurations, wherein each CSI report configuration of the one or more CSI report configurations configures one or more CSI reports;
determining, by the network device, a number of CSI processing units (CPUs) occupied by one or more CSI reports configured by a CSI report configuration of the one or more CSI report configurations; and
receiving, by the network device, one or more sets of CSIs processed based on the number of CPUs occupied by the one or more CSI reports.

16. The method of claim 15, wherein the one or more CSI reports comprises a single CSI report comprising multiple sets of CSIs for reporting by the wireless device,
wherein the number of CPUs occupied by the one or more CSI reports is equal to Kₛ*n, wherein Kₛ is a number of CSI reference signal (CSI-RS) resources in a CSI-RS resource set for channel measurement, and wherein n is a number of sets of CSIs reported in the single CSI report.

17. An apparatus for wireless communication comprising at least one processor and a memory storing instructions, execution of which by the at least one processor causes the apparatus to perform operations comprising:
receiving one or more channel state information (CSI) report configurations, wherein each CSI report configuration of the one or more CSI report configurations configures one or more CSI reports;
determining a number of CSI processing units (CPUs) occupied by one or more CSI reports configured by a CSI report configuration of the one or more CSI report configurations; and
processing one or more sets of CSIs based on the number of CPUs occupied by the one or more CSI reports.

18. The apparatus of claim 17, wherein the CSI report configuration is associated with a CSI reference signal (CSI-RS) resource, and
wherein the processing the one or more sets of CSIs comprises the apparatus using a part of or all ports associated with the CSI-RS resource for CSI report calculation and reporting multiple sets of CSIs.

19. The apparatus of claim 17, wherein the CSI report configuration is associated with a CSI reference signal (CSI-RS) resource configured with multiple antenna patterns, wherein the one or more CSI reports comprises a single CSI report comprising multiple sets of CSIs according to the multiple antenna patterns for reporting by the apparatus, and wherein an antenna pattern of the multiple antenna patterns includes at least one of the following: a port index indication, a group indication or a power offset.

20. The method of claim 17, wherein the one or more CSI reports comprises a single CSI report comprising multiple sets of CSIs for reporting by the apparatus,
wherein the number of CPUs occupied by the one or more CSI reports is equal to Kₛ*n, wherein Kₛ is a number of CSI reference signal (CSI-RS) resources in a CSI-RS resource set for channel measurement, and wherein n is a number of sets of CSIs reported in the single CSI report.
